(19) United States
(12) Patent Application Publication
(10) Pub. No.: US 2020/0094262 A1
(43) Pub. Date: Mar. 26, 2020

(54) APPARATUS AND METHOD FOR SEPARATING MATERIALS USING STRATIFICATION

(71) Applicant: Thomas Valerio, Atlanta, GA (US)

(72) Inventor: Thomas Valerio, Atlanta, GA (US)

(21) Appl. No.: 16/465,522

(22) PCT Filed: Nov. 30, 2017
(86) PCT No.: PCT/US2017/064082

§ 371 Date: May 30, 2019

Related U.S. Application Data
(60) Provisional application No. 62/428,520, filed on Nov. 30, 2016.

(51) Int. Cl. B03B 5/38; B03B 5/62; B03B 13/00

(52) U.S. Cl. CPC B03B 5/38; B03B 13/00; B03B 5/623

(57) ABSTRACT

A system multiple having units in a linear arrangement employs density separation processes. In one arrangement, the system provides more control over the agitation and forces separating the material. One system has a paddlewheel 115, 215 in some or all of the units to create movement to optimize the residence time (faster or slower) to optimize separation.

### TECHNICAL FIELD

This application relates to an apparatus for sorting materials. More specifically, this application relates to an apparatus that employs a paddlewheel or the like inside a multiunit module or linear system that allows water to pass through in order to sort and recover materials from waste materials.

### BACKGROUND

Recycling of waste materials is highly desirable from many viewpoints, not the least of which are financial and ecological. Properly sorted recyclable materials often can be sold for significant revenue. Many of the more valuable recyclable materials do not biodegrade within a short period. Therefore, recycling such materials significantly reduces the strain on local landfills and ultimately the environment.

Typically, waste streams are composed of a variety of types of waste materials. One such waste stream is generated from the recovery and recycling of automobiles or other large machinery and appliances. For example, at the end of its useful life, an automobile will be shredded. This shredded material can be processed to recover ferrous metals. The remaining materials, referred to as automobile shredder residue (ASR) typically would be disposed in a landfill. Recently, efforts have been made to recover additional materials from ASR, such as plastics and non-ferrous metals. Similar efforts have been made to recover materials from whitegood shredder residue (WSR), which are the waste materials left over after recovering ferrous metals from shredded machinery or large appliances. Other waste streams may include electronic components, building components, retrieved landfill material, incinerator ash which can be bottom ash or combined ash, and other industrial waste streams. These materials generally are of value only when they have been separated into like-type materials. However, in many instances, cost-effective methods are not available to effectively sort waste streams that contain diverse materials. This deficiency has been particularly true for non-ferrous materials.

This combination of diverse materials and diverse material sizes, densities, shapes and moisture content provide a unique challenge in separating and recycling specific materials in an efficient manner. The ability to efficiently separate and concentrate recyclable materials at high throughputs from the different waste streams reduces the negative environmental impact of these materials, as less of this residue will be disposed of in landfills.

### SUMMARY

This disclosure generally provides a system for separating materials in a waste stream. The system includes a feeder or an infeed conveyor and one or more sorting units. Each of the one or more sorting unit comprises a processing container, an inlet, an outlet, a paddlewheel, an axial connection, and a discharge device configured to allow discharge of a stratified waste material. A processing media is also included within the processing container and the processing media comprises a given specific gravity. The paddlewheel is configured to rotate in a manner that generates an agitation of the processing media within the sorting unit. The axial connection is configured to generate a vertical motion of the processing media within the sorting unit. The infeed conveyor is configured to introduce the waste stream into the inlet of a first sorting unit. In operation, the agitation and vertical motion of the processing media is configured to separate the waste stream into at least a light portion and a heavy portion within each of the one or more sorting units. The discharge device of the first sorting unit is configured to receive and discharge the heavy portion from the processing container of the first sorting unit. The outlet of the first sorting unit is configured to receive the light portion from the processing container of the first sorting unit.

Also disclosed is a method of separating materials in a waste stream using the sorting apparatus described above.

These and other features of the embodiments disclosed herein will become more fully apparent from the following description and appended claims.

### BRIEF DESCRIPTION OF DRAWINGS

FIG. 1 is a schematic view of the density separator according to the present disclosure having multiple units.

FIG. 2 is a perspective view of another embodiment showing three more units.

FIG. 3 is a process flow diagram illustrating a method for separating materials in a waste stream in three-unit embodiment in accordance with the present disclosure.

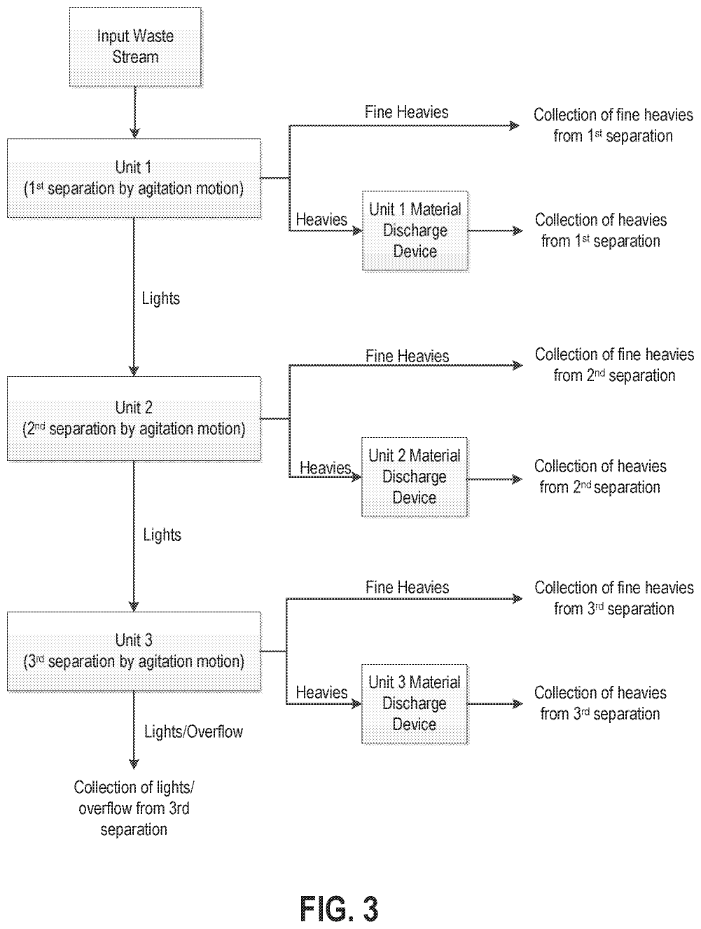

FIG. 4 is a perspective side view of a density separator with multiple units and the associated feeder conveyor.

FIG. 5 provides a top view of the density separator and feed conveyor of FIG. 4.

FIG. 6 provides a side view of the density separator and feed conveyor of FIG. 4 and the paddlewheels have been removed from each of the three units.

### DETAILED DESCRIPTION

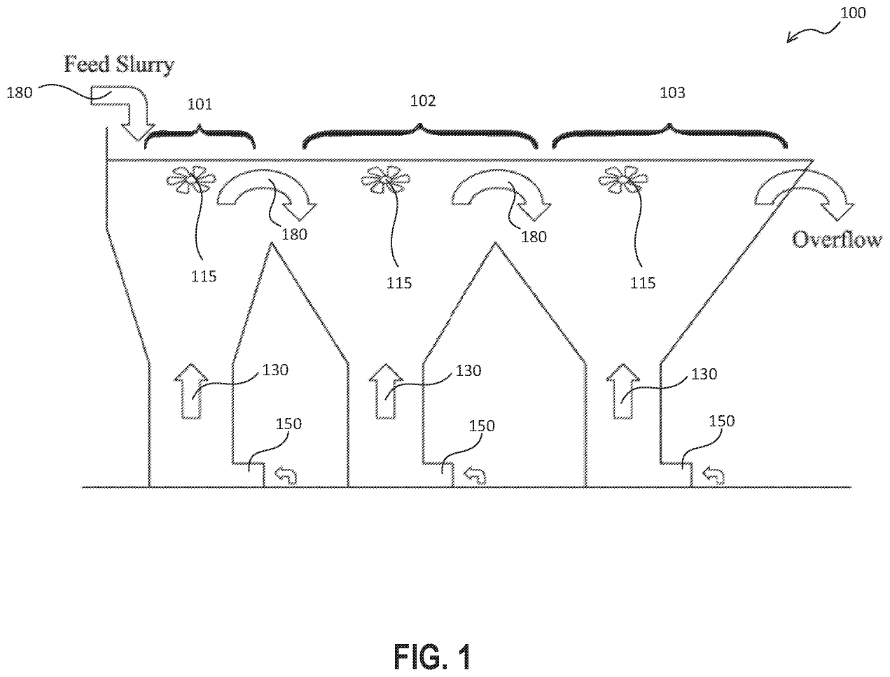

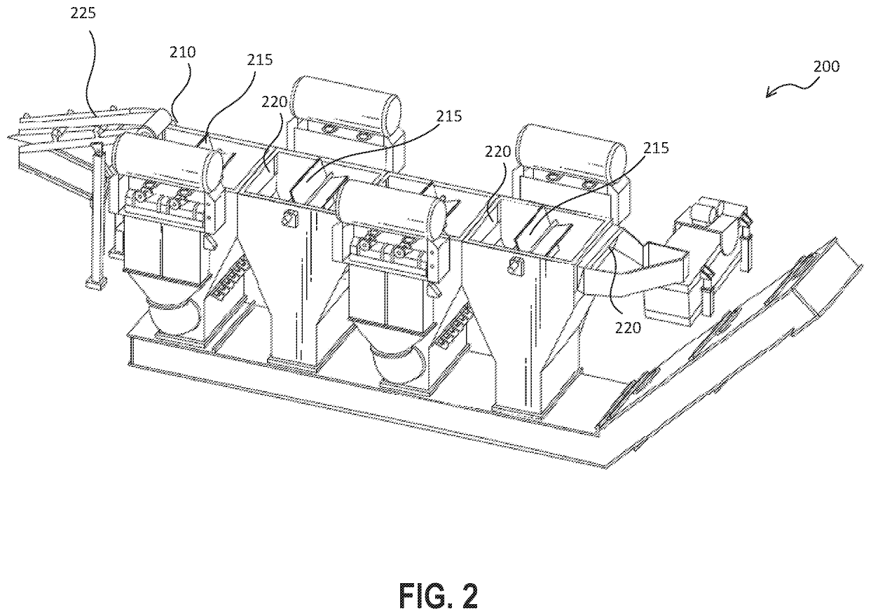

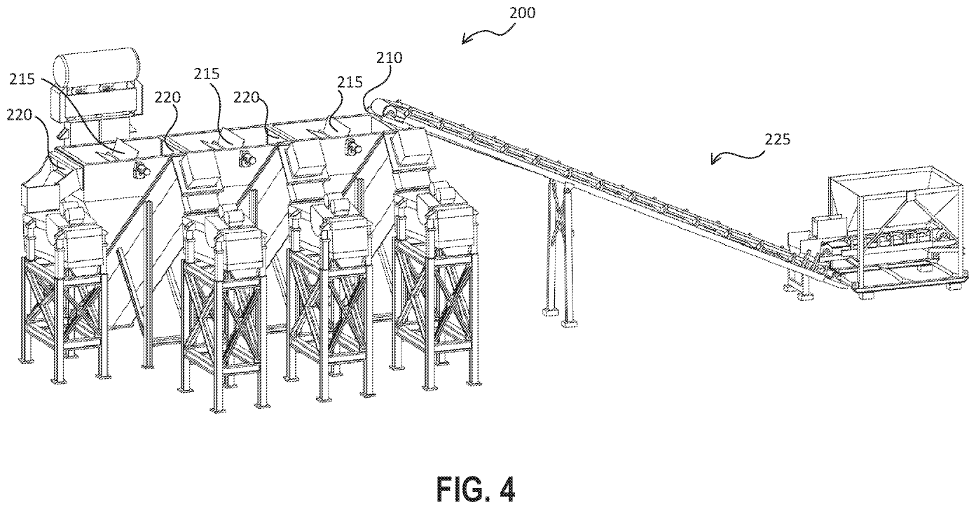

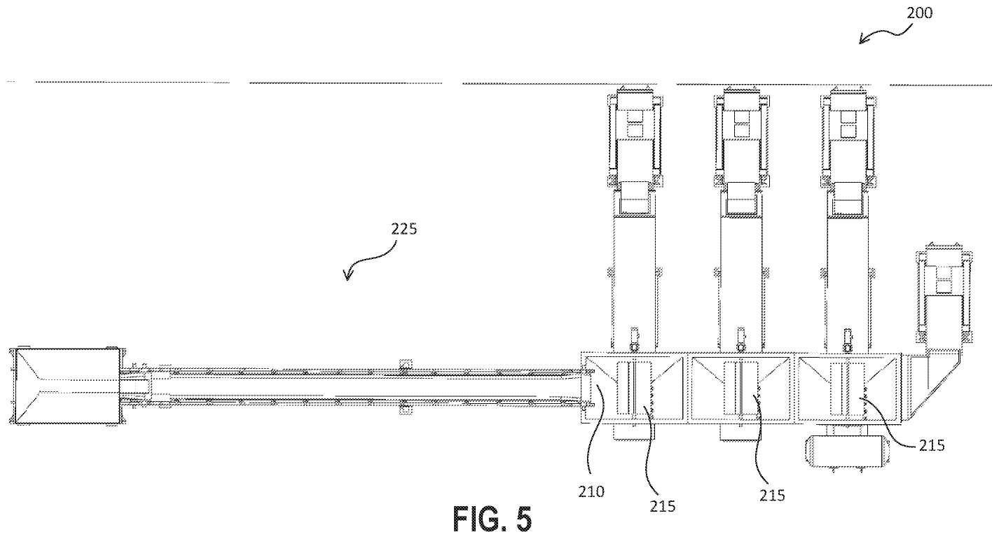

In general, this disclosure includes methods and systems for separating materials in a waste stream 180. The present disclosure presents a sorting apparatus with the use of up/down (or vertical) motion flow of water or other media, which can be thought of as a cascaded density separator. A sorting apparatus may include, e.g., a multiunit system 100, 200, together referred to as a linear system. The multiunit system has units that are one or more rectangular or conical units in a linear arrangement. See, e.g., FIGS. 1-2 and FIGS. 4-6. In one example, the multiunit system includes a rectangular housing having an interior surface, an inlet 210 and an outlet 220. In one embodiment, a waste stream 180 is introduced into the inlet 210 of a first separator unit 101, 201 via an infeed conveyor 225.

Water or other media can fill each or all of the units to a predetermined level. Each of the units, e.g., at or near the top of the multiunit system, can have a mixer or a paddlewheel 115, 215 or similar component (capable of moving water) that may be powered (or unpowered) to agitate the water in an up/down motion. When the water hits the rotating paddlewheel 115, 215, the energy of the paddlewheel 115, 215 is transferred to the water, forcing the water out to move or pulse. The water is displaced outward, and more water can now enter the suction side of the pump to replace the displaced water. Materials to be sorted can enter the unit through a feed chute/inlet 210 located, e.g., on the top of the unit next to or above the paddlewheel 115, 215.

In one example, the paddlewheel 115, 215 comprises a shaft that extends from the center-top portion of the unit down towards the middle cone. On the bottom of the shaft, fixed paddles are provided. In operation, the paddlewheel 115, 215 rotates to generate an agitation of the water. The motion generated by the paddlewheel 115, 215 can be controlled motion, e.g., through control of the paddlewheel 115, 215. In contrast to a quiet/stable bath, the paddlewheel 115, 215 and other elements can provide an active bath with a motion and shear forces in each of the units.

The stratification from the vertical motion or up/down motion is generated through an axial connection 150. Such connection allows for water or other media 130 to be entered into the unit. Such water or media that enters through the axial connection generates an upward and downward motion 130, therefore the third-dimension of the separation apparatus. The axial connection 150 may also be tangential and in the form of a chamber. One example of the stratification apparatus can be an air-over-water pulsating chamber. In such an example, air inside a chamber expands and contracts creating an upward and downward flow of water into the unit through the axial or tangential connection.

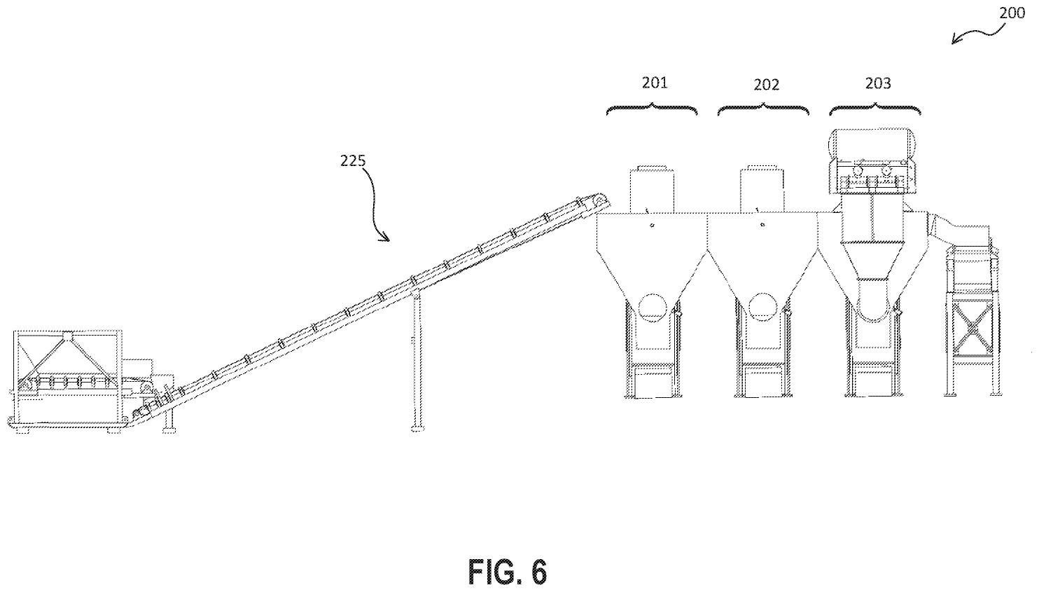

In one embodiment, as shown in FIGS. 1 and 6, the apparatus includes multiple rectangular/box-shaped units to provide more control over the agitation and forces separating the material. More specifically, in this arrangement, the slurry or waste stream 180 is fed into the first unit 101,201, and from the first unit, the slurry or waste stream 180 flows into the second unit 102, 202, and from the second unit the slurry or waste stream 180 flows into the third unit 103, 303, and so forth. The paddlewheel 115, 215 in some or all of the units creates agitation, a shear force, and an upward/rising current 130. Further, sensors, whether in the units or outside thereof, can be operatively linked to the paddlewheel 115, 215 to maintain a desired agitation state within the units. The frequency and the amplitude of the forces/waves in the units can be set to optimize separation efficiencies. These parameters can be used to control the residence time of particles.

In another embodiment, each unit can be set to create a separation based on a specific gravity separation that may be preset or dynamic. For example, one unit could separate using multiple parameters—that one or more of the units may have water with a rising current at 1.0 SG and another could use 1.6 SG. Each unit can have its own and separate specific gravity separation.

The agitation motion and shear forces allow for materials to move inside the units. The resulting action causes heavier particles to be liberated from the lighter particles. The heavier recyclables that sink to the bottom are discharged at the bottom of the unit with the use of a discharge device such as a movable gate or rotary valve or any other device to move the heavier particles or that prevent the continuous discharge of water but allows the heavier recyclables to exit when the device is energized. The lighter materials stay in suspension on the top of the unit are eventually discharged continuously by the carrying circular current through a tangential passage located on the high side of the unit.

The rotational speed of the paddlewheel 115, 215 as well as the frequency and stroke of the stratification apparatus of the unit may be varied to optimize the separation process. Without intending to be bound to specific theory, these two effects are combined into a single separation unit in which several principles come into play such as the Archimedes Principle, which explains how the apparent weight of an object immersed in water decreases. Other principles applied due to the density separation includes the Hindered Settling effect, the Consolidation Trickling effect, as well as the Jerk Effect also referred to as the Jolt Surge effect that is caused by both the motion created by the paddlewheel 115, 215 and the upward/downward movement of the stratification component. The paddlewheel need not be in each and every unit.

The upward and/or downward motion of the water or media 130 enhances the separation by reducing the amount of lighter materials that are misplaced or entangled with heavier materials that sink to the bottom of the density separator. Such upward and downward motion 130, referred to as the third separation dimension, can be provided through the axial or tangential pipe 150 or chamber in the form of pulses that generate upwards and downward currents or pulses of water or other media. Such inflow and outflow of water to the unit generates a rising current of water 130 that improves the separation efficiency and a downward flow of water allows for the heavier particles to stratify.

The heavier materials that sink are discharged through a material discharge device such as a valve, gate, rotary valve, sealed bucket conveyor or sealed screw conveyor to allow for the heavier materials to exit the unit while reducing the amount of water or media that flows therethrough. The additional water or media that is required to make up for the lost water or media that abandons the unit through the lighter material discharge, fine heavier material discharge or the heavy material discharge zones may be added through the pulse chamber. The separated products produced in the density separation apparatus may be designated as follow: (1) the “lights”, which are discharge through an exit passage located on the top of the top of each unit; (2) the “fine heavies” or “hutch product”, which consists of fine particles that have a specific gravity large enough that they sink to the bottom of the unit; and (3) the “heavies”, which consists of the heavies that sank to the bottom of the unit. The heavies can be collected by one or more conveyors or drag conveyors.

In an alternate embodiment, the axial or tangential pipe or chamber 150 may generate a constant inflow of water or media rather than constant pulsating streams of water. Such continuous upflow of water will still generate a dimension of separation to enhance the efficiency of the separation and may be used when processing different materials. For example, the pulsating upward and downward motion may be used when processing prone to entanglement recyclables such as recyclables containing insulated or bare wire. The inflow and outflow of water will reduce the chances for light recyclables from ending on the heavy fraction.

In another embodiment, the media or fluid used in the recovery system may be any liquid capable of washing the materials and causing the metal to suspend into the process fluid. In other embodiments, the recovery system may use chemicals which can extract and suspend the desired constitute. Examples of such solutions are well known to those of skill in the art. One example of such a solution is water. In other embodiments, chemicals, minerals and or any magnetic material that can be used to change the specific gravity of the fluid to obtain an actual constant specific gravity range of 1.0 to 3.0 SG depending on the application.

In another embodiment, in some cases the media or fluid includes inorganic dirt, sand, glass fines, ferrous fines and combinations thereof. In such cases, the apparatus can use inorganic media fines that can come from automobile shredder residue fines, shredder fines from Hammermill operations, ferrous slag or inorganic fine byproducts from incineration and/or pyrolysis operations. Further, other minerals that may be mixed in a landfill containing metals can be recovered.

By using media with a specific gravity of 1.5 SG or higher, the costs to an operator can be reduced or nullified, that is, the costs to the operator may be net zero. Media with a specific gravity of 1.5 SG or higher can be separated into organics and inorganics.

The apparatus can have sensors connected to computers that incorporate algorithms to maximize efficiencies of the separation. The computer algorithms can optimize variables (e.g, paddlewheel 115, 215 speed) to obtain a desired separation.

The vertical motions of the density separator enhances the separation efficiency of the materials by processing high throughputs and reducing the limitations of typical recyclable materials such as moisture content and the necessity of a discrete size range. The density separator may provide a cost-effective method of concentrating recyclable materials into discrete specific gravities doing so at higher throughputs than typical sorting technologies. Such discrete specific densities are determined by the frequency, amplitude, or speed of the water or media generated by the paddlewheel 115, 215 as well as by the inflow and outflow of water through the bottom pipe or pulse chamber.

### EXAMPLES

FIGS. 1-2 and 4-6 show an exemplary apparatus or system employing the density separation process having multiple units in a linear arrangement 100, 200. In this arrangement, the apparatus or system provides more control over the agitation and forces separating the material. More specifically, in this arrangement, the slurry or waste stream 180 is fed into the unit 101, 201, and from the unit, the slurry or waste stream 180 flows to the second unit 102, 202 and so forth. The paddlewheel 115, 215 in some or all of the units creates movement to optimize the residence time (faster or slower) to optimize separation. Further, sensors, whether in the units or outside thereof, can be operatively linked to the paddlewheels to maintain a desired state within the units. Each of the units may have its own motor and driver. A constant flow of water or media 130, or a pulsating flow of water or media 130, is provided through an inlet pipe or chamber 150 connected to the bottom of one of the units. Again, the “heavies” discharge through a chute through a drag chain conveyor. The lights discharge passage can be provided with a de-watering screen or similar de-watering device such as a de-watering conveyor, screw conveyor or bucket elevator.

In one example, a first unit 101, 201 could be used to separate absorbent organics such foam, cloth or other absorbent materials that may absorb media (e.g, magnetite, sand). In another example, the first unit 101, 201 has a 1.0 SG (e.g., to separate organics), a second unit 102, 202 has a 1.2 sg (to separate valuable plastics, such as polystyrene or non-filled plastics), and a third unit 103, 203 has a 1.6 sg (organics vs. inorganics). Metal and minerals can be recovered from the third unit 103, 203.

1. A system for separating materials in a waste stream, comprising:
a feeder;
two or more sorting units arranged in fluid connection and in a serial and linear configuration, each sorting unit comprising a processing container, an inlet, and an outlet;
a processing media disposed within the processing container, wherein the processing media comprise a specific gravity; a mixer or paddlewheel configured to rotate in a manner that generates an agitation of the processing media within the sorting unit; an axial connection configured to generate a vertical motion of the processing media within the sorting unit; a discharge device configured to allow discharge of a stratified waste material;
wherein the feeder is configured to introduce the waste stream into the inlet of a first sorting unit of the two or more units; the agitation and vertical motion of the processing media is configured to separate the waste stream into at least a light portion and a heavy portion within each of the one or more sorting units; the discharge device of the first sorting unit is configured to receive and discharge the heavy portion from the processing container of the first sorting unit; and the outlet of the first sorting unit is configured to receive the light portion from the processing container of the first sorting unit.

2. The system of claim 1, further comprising
a second sorting unit of the two or more units, wherein the inlet of the second sorting unit is configured to receive the light portion from the outlet of the first sorting unit, wherein the discharge device of the second sorting unit is configured to receive and discharge the heavy portion from the processing container of the second sorting unit; and the outlet of the second sorting unit is configured to receive the light portion from the processing container of the second sorting unit, wherein the first unit and the second unit are adjoining and in fluid connection; and the axial connection is configured to introduce an inflow of processing media into the processing container of the first unit such that the inflow generates the vertical motion of the processing media within the first sorting unit.

3. The system of claim 1, wherein the processing media comprises water.

4. The system of claim 1, wherein the processing media comprises chemicals, minerals, magnetic materials, or a combination thereof.

5. The system of claim 1, wherein the processing media comprises inorganic dirt, sand, glass fines, ferrous fines, automobile shredder residue fines, shredder tines from Hammermill operations, ferrous slag or inorganic fine byproducts from incineration and/or pyrolysis operations, or combinations thereof.

6. The system of claim 1, wherein the specific gravity of the processing media varies between the two or more sorting units.

7. The system of claim 1, wherein the discharge device is further configured to prevent an incidental discharge of processing media upon discharge of the stratified waste material.

8. The system of claim 7, wherein the discharge device comprises a valve, a gate, a rotary valve, a sealed bucket conveyor, a sealed screw conveyor, or a combination thereof.

9. The system of claim 1, wherein the processing container is rectangular or conical in shape.

10. The system of claim 1, wherein the feeder to the first unit is an infeeder conveyor.

11. The system of claim 1, wherein the specific gravity of the media on unit is about 1.0, the specific gravity in a second unit of the two or more units is about 1.2, and the specific gravity in a third unit of the two or more units is 1.6.

12. (canceled)

13. The system of claim 12, wherein the inflow of processing media is configured to introduce pulsating streams of processing media into the sorting unit.

14. The system of claim 1, wherein the axial connection comprises an air-over-processing-media chamber, wherein air is disposed over a volume of processing media that is in fluid communication with the processing media disposed within the processing container; the chamber being configured such that expansion or contraction of the air creates the vertical motion of the processing media within the sorting unit.

15. The system of claim 1, wherein the waste stream comprises incinerator ash, automobile shredder residue, whitegood shredder residue, e-waste, building components, waste-to-energy slag, steelmaking slag, ferrochrome slag, retrieved landfill material, or a combination thereof.

16. The system of claim 1, further comprising a controller to control a rotational speed of the paddlewheel; a frequency of agitation; an amplitude of agitation, wherein the rotational speed is adjustable such that the frequency of agitation, amplitude of agitation, or a combination thereof is customizable within the unit.

17. A system for separating materials in a waste stream, comprising: a feeder; one or more sorting units arranged in fluid connection, each sorting unit comprising a processing container, an inlet, and an outlet; a processing media disposed within the processing container, wherein the processing media comprise a specific gravity; a mixer or paddlewheel configured to rotate in a manner that generates an agitation of the processing media within the sorting unit; an axial connection configured to generate a vertical motion of the processing media within the sorting unit; a discharge device configured to allow discharge of a stratified waste material; wherein the feeder is configured to introduce the waste stream into the inlet of a first sorting unit of the two or more units; the agitation and vertical motion of the processing media is configured to separate the waste stream into at least a light portion and a heavy portion within each of the one or more sorting units; the discharge device of the first sorting unit is configured to receive and discharge the heavy portion from the processing container of the first sorting unit; and the outlet of the first sorting unit is configured to receive the light portion from the processing container of the first sorting unit; and a sensor operatively linked to the paddlewheel; a processing system communicatively linked to the sensor; wherein the sensor is configured monitor an agitation state of the processing media within the unit; and the processing system is configured to receive the agitation state from the sensor and apply algorithms to optimize paddle wheel rotation to obtain a desired waste stratification.

18. A method of separating materials in a waste stream, comprising: receiving the material into a sorting apparatus, wherein the sorting apparatus comprises an infeed conveyor and two or more sorting units in a serial and linear configuration, each sorting unit comprising a processing container; an inlet; an outlet; a paddlewheel; a discharge device; and an axial connection; filling the processing container of the one or more sorting units to a desired level with a processing media, wherein the processing media has a specific gravity; wherein the infeed conveyor delivers a waste stream through the inlet of a first sorting unit and into the processing container of the first sorting unit; rotation of the paddle wheel agitates the processing media within the sorting unit; the axial connection generates a vertical motion of the processing media within the sorting unit; the agitation and vertical motion of the processing media separates the waste stream by density into at least a light portion and a heavy portion within each of the one or more sorting units; the discharge device of the first sorting unit receives and discharges the heavy portion from the processing container of the first sorting unit; and the outlet of the first sorting unit receives the light portion from the processing container of the first sorting unit.

19. The method of claim 18, wherein the sorting apparatus comprises two or more sorting units in a serial and linear configuration and adjoined; the specific gravity of the processing media varies from one unit to the next; and the waste stream moves sequentially from the outlet of the first sorting unit to inlet of the next sorting unit in the linear, serial configuration such that, after the first sorting unit, each of the following sorting units receives the light portion from the outlet of the immediately preceding sorting unit in the linear, serial configuration.

20. The method of claim 18, wherein the agitation of the processing media comprises a given frequency, a given amplitude, or a combination thereof that is correlated with a rotational speed of the paddle wheel; and specific densities into which the waste stream is separated are refined by adjustment of the rotational speed of the paddle wheel to alter the frequency, amplitude, or a combination thereof of the agitation of the processing media.

21. The method of claim 18, wherein the axial connection introduces an inflow of processing media into the processing container such that the inflow generates the vertical motion of the processing media within the sorting unit.

22. (canceled)

23. (canceled)
